(19) United States
(12) Patent Application Publication
(10) Pub. No.: US 2009/0172872 A1
(43) Pub. Date: Jul. 9, 2009

(54) Disposable Flatpack Potty or Bedpan

(75) Inventors: David Richard Macey, Wetherby (GB); Maree Brandy Macey, Wetherby (GB)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: POTEEZ LIMITED, Wetherby (GB)

(21) Appl. No.: 11/817,092

(22) PCT Filed: Feb. 24, 2006
(86) PCT No.: PCT/GB2006/000685

§ 371 Date: Apr. 21, 2008

(30) Foreign Application Priority Data
Feb. 25, 2005 (GB) 0503901.1

(51) Int. Cl. A61G 9/00

(52) U.S. Cl. 4/451

(57) ABSTRACT

A disposable potty formed by folding a substantially flat blank into an erect condition, characterised in that at least one surface of the blank is liquid-resistant. The potty can be flat-packed efficiently prior to use. The potty can be double-walled to provide strength, and liquid-resistant on both the inside and the outside of the potty.

The invention to which this application relates is a disposable flatpack container for use as a potty or bedpan, hereinafter referred to as a potty.

In places such as hospitals, it can be difficult to provide toilet facilities where storage is a limiting factor before or after use. Existing devices such as bedpans and plastic potties are hard to store, tend to get crushed through use, are uncomfortable, and are not covered after use, which presents a health risk to patients and staff through the risk of spillage.

Another problem exists for young children where they may need to go to the toilet relatively quickly and no normal toilet facilities are available within the facility. In other areas such as when travelling there may be a need, especially for young children, to have access to a potty for use before a service station can be reached. If a potty is not available this can lead to the child having to excrete at, for example, the roadside which is unhygienic and unpleasant for the child.

In addition, it can be difficult to dispose of the waste material from within the toilet. For example, in hospitals, or in third world areas where no water based sewage system is available, the waste tends to require incineration, so needs to be transported to an incinerator. This increases the potential health risk described above as it is difficult to collect and transport the material safely.

An aim of the present invention is to provide a container for waste material, such as a potty, which can be easily stored before use and disposed of thereafter and which can be used to contain the waste material therein at least for a sufficient time for a suitable waste disposal area to be found.

In a first aspect of the invention there is provided a potty characterised in that said potty is movable from a blank or flatpack condition to an erected condition for use.

In one embodiment the potty when erect defines a cavity therein capable of containing liquid and/or other material.

Preferably the potty is formed of sheet material and at least that portion or portions of the sheet material which define the walls of the cavity when the potty is formed are coated to be liquid-resistant for at least a predetermined period of time to allow the waste material to be stored within the cavity without leakage occurring through the sheet material.

In one embodiment an aperture is defined in the top surface of the potty in relation to which a person positions themselves for use of the potty.

In one embodiment the potty is formed from a blank of sheet material and at least one side of the sheet material has a liquid resistant coating applied thereto.

Typically the blank can be flat-packed and is typically of a sheet material such as cardboard, so that the same can be efficiently stored prior to use.

Typically the potty includes one or more lines of weakening to allow erection thereof by folding.

Typically the blank includes two or more sections, and engagement means are provided on the sections to allow retention of the sections to form the erect potty.

In one embodiment, the blank includes two main sections forming the base and side walls, and the lid of the erect potty.

Typically one section is folded inwardly to form the base and side walls, and the other section is folded inwardly to form the lid. Typically the base and side walls are then folded into the lid to form the erect potty.

In a further embodiment, the blank includes three main sections forming the base exterior, base interior and lid of the erect potty, the sections including side walls as required to form the potty.

Typically the first section is folded inwardly to form the base exterior of the erect form. Typically the second section is folded outwardly then folded into the base exterior to form the base interior of the erect form. Typically the third section is folded inwardly then folded into the base exterior to form the lid of the potty.

Thus the body of the potty is double walled such that if the base interior leaks, the base exterior contains the leak within the potty.

Typically at least one section is folded inwardly at the corners to move the same into an erected condition, the outer portions of the section forming walls in the erected condition. The corners in the erected condition form points which can either extend along the outside and substantially in parallel with the walls, or extend inwardly from the walls into the cavity of the potty. To prevent discomfort of the latter to a user, the points are folded back on themselves to reduce the distance that the same extend from the walls.

Typically the third section includes one or more lines of weakening and/or frangible portions to allow an aperture to be defined in the lid.

In one embodiment the liquid-resistant surface(s) are located on the blank such that when the potty is erected the surfaces of the cavity defined within the potty are liquid-resistant.

In one embodiment the blank has one liquid-resistant surface and is folded such that the exterior and the interior of the erected potty are liquid-resistant.

In one embodiment the potty includes one or more handles.

In one embodiment the potty is provided with sealing means. Typically the handles interlock to seal the potty shut. Typically the handles are provided with adhesive strips to seal the potty shut.

In one embodiment the blank is manufactured from a disposable material, typically cardboard or corrugated board.

In a second aspect of the invention, there is provided a blank of sheet material including at least two sections, said sections provided with one or more lines of weakening to allow erection of the blank by folding the same into a base, walls, and a lid, characterised in that at least one surface of the blank is liquid-resistant

In one embodiment the blank includes at least three sections, said sections provided with one or more lines of weakening to allow erection of the blank by folding the same into a base exterior and exterior walls, a base interior and interior walls, and a lid.

In one embodiment both surfaces of the blank are liquid-resistant. Typically the blank is erected to form a potty and defines a cavity therein, the walls and base of which are formed by the liquid resistant surface of the blank.

In a fourth aspect of the invention, there is provided a disposable potty formed by folding a substantially flat blank into an erect condition, characterised in that at least one surface of the blank is liquid-resistant.

Specific embodiments of the invention are now described wherein:—

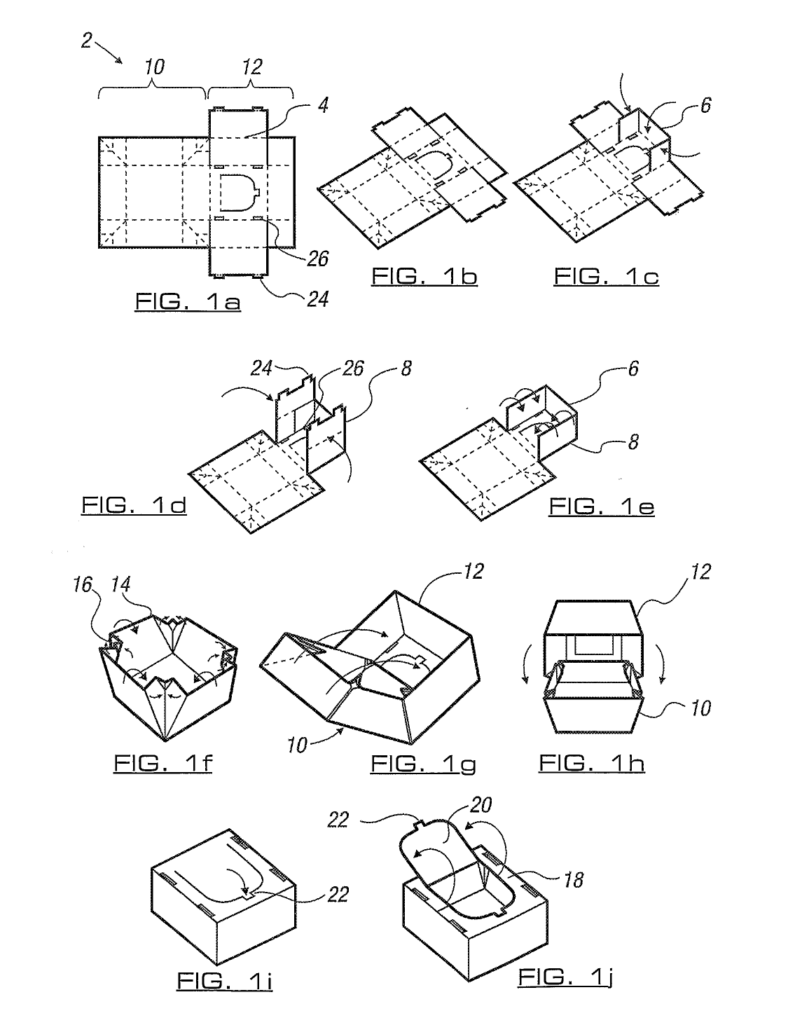

FIGS. 1a-j illustrate a potty being erected according to a first embodiment of the invention.

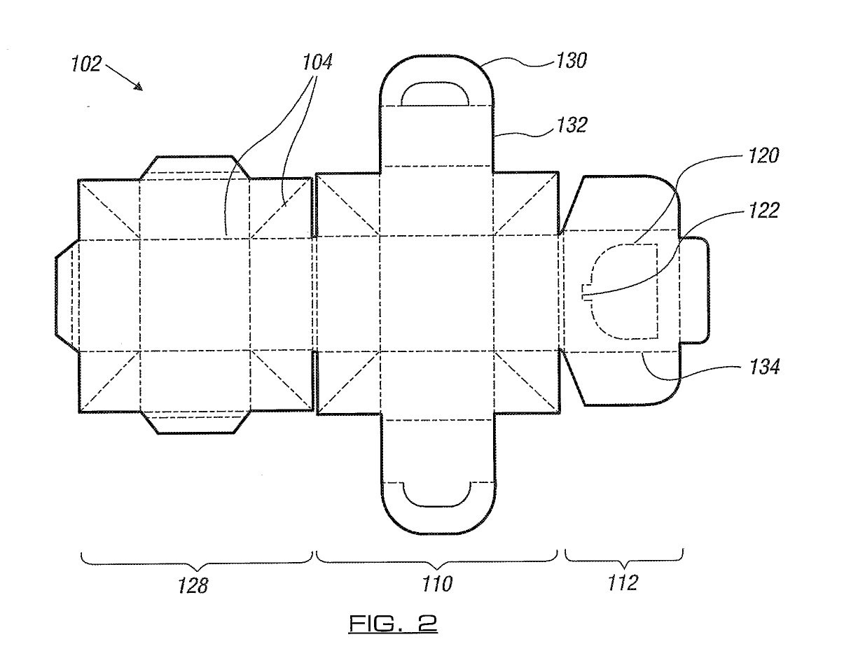

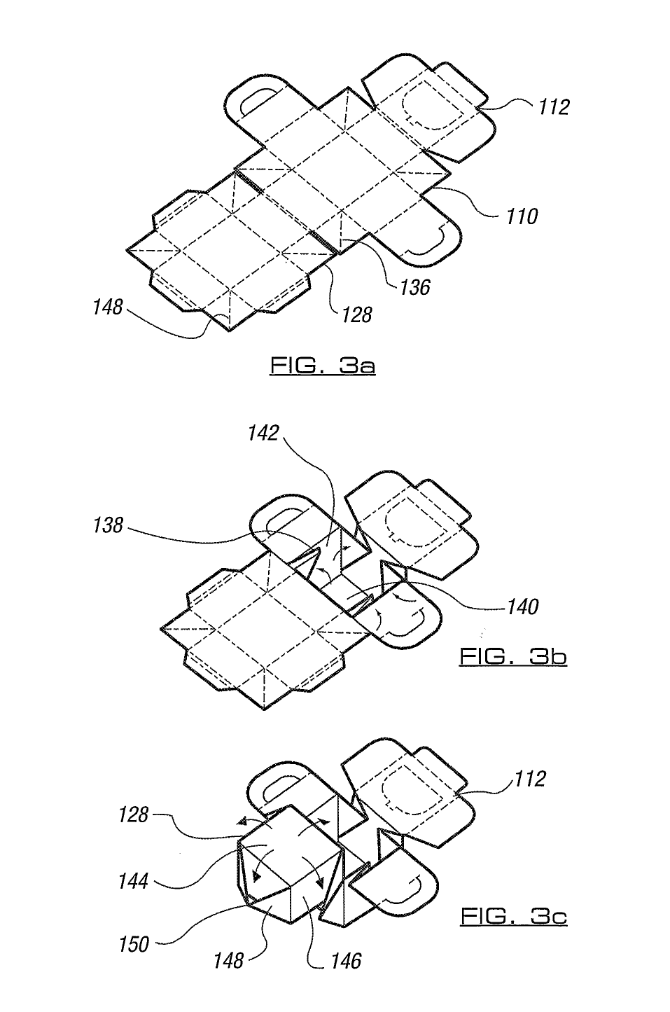

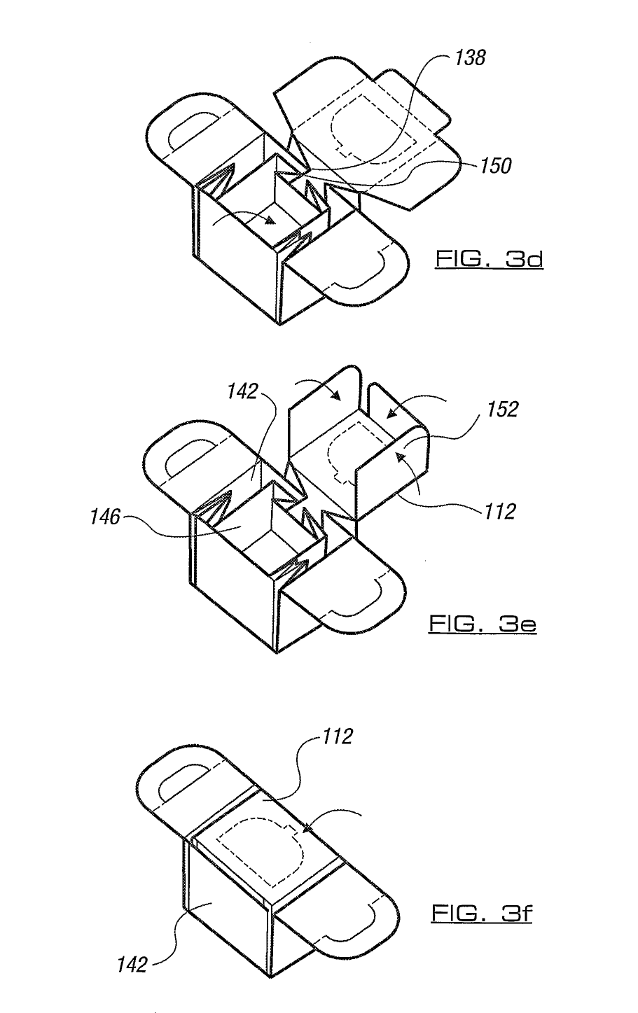

FIG. 2 illustrates a blank for a potty according to a second embodiment of the invention.

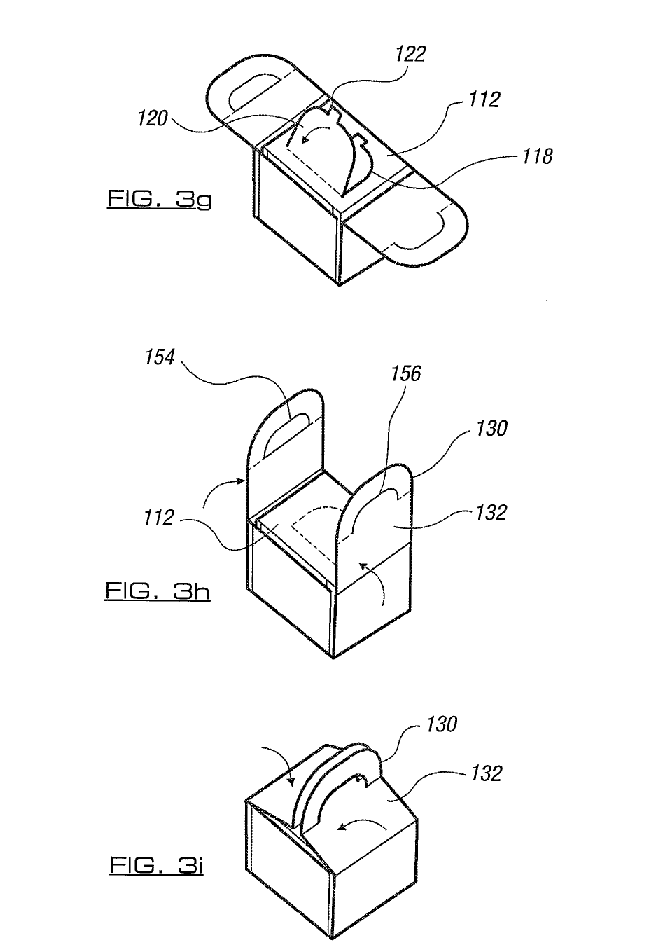

FIGS. 3a-j illustrate the blank of FIG. 2 being erected to form a potty.

With reference to FIG. 1a, there is illustrated a blank 2 comprising two sections, a base section 10 and a lid section 12, with a plurality of weakened lines 4 so that the blank 2 can be folded into a container such as a potty.

To erect the potty, the blank is arranged on a flat surface as shown in FIG. 1b, and the end panel 6 is turned up as shown in FIG. 1c. The side panels 8 are then turned up as shown in FIG. 1d, and then folded over the end panel 6 as shown in FIG. 1e. The side panels 8 are provided with locking means in the form of tabs 24 which engage slots 26 to lock the side panels in position.

FIG. 1f shows the inward folding of the base panels 14 of the base section which is resistant to liquids such as water. The double fold back method enables the interior of the base to retain its watertight state. The corners 16 are folded at 90 degrees until the side panels 14 of the base meet whilst the top of the corner 16 is folded back on itself at 90 degrees for stability and to prevent their length protruding into the aperture 18 at the seat of the potty which could cause discomfort to the user.

The base section 10 is then folded into the lid section 12 as indicated in FIGS. 1g and 1h to form the erected container as a potty with a seat 20, ready for use as shown in FIG. 1i. The tab 22 of the seat 20 can be pulled to form the aperture 18 and allow material to be put into the cavity therein.

With reference to FIG. 2, there is illustrated a blank 102 for a potty comprising three sections in accordance with another embodiment of the invention. As shown in FIGS. 3a-i, the potty is erected in a similar fashion to the erection of the potty of FIGS. 1a-i.

With reference to FIGS. 3a-b, the base section 110 is folded inwardly to form the base exterior with a base 140 and walls 142. The corners 136 of the base section extend inwardly from the walls when erected, forming points 138. In this embodiment it is not necessary to fold back the points on themselves as will be explained below.

With reference to FIG. 3c, the additional section 128 is folded outwardly to form a base interior of similar shape, with a base 144 and walls 146, wherein the corners 148 form points 150 which extend outwardly from the walls when erected.

Referring to FIG. 3d the base interior is then folded into the base exterior such that the respective points 150, 138 are held between the walls of the same. Thus, the points do not extend into the cavity of the potty.

Only one side of the blank is liquid-resistant, but due to the way in which it s folded the base exterior exposed to the outside and the base interior exposed to the cavity within the erected potty are both liquid-resistant. This provides a dual layer of protection should the base interior leak, and extra strength through providing a double layer. The liquid-resistant surface can be formed by printing a design thereon and then applying a layer of varnish.

With reference to FIG. 3e, the lid section 112 is then folded to form the lid of the potty with tabs 152, which, as shown in FIG. 3f, locates between the walls 142, 146 of the base interior and base exterior to hold the same in position when the lid is folded down onto the base.

Referring to FIG. 3g and as hereinbefore described, the lid section 112 is provided with a seat 120 which opens to form an aperture 118 by pulling on the tab 122.

With reference to FIG. 3h, handles 130 are also provided to allow the potty to be carried easily. The handles can also be provided with adhesive to allow the body 132 thereof to be folded down and secured to the lid 112 as shown in FIG. 3i, thereby sealing the potty after use to help prevent spillage and contain the contents within the cavity. One handle subsection 156 remains planar with the body 132, whereas the other handle subsection 154 folds to define an aperture to receive the first subsection 156 when the handles are folded down as described, to lock the handles 130 together.

Thus, if an adult is travelling with a small child who needs to use a toilet, but there are no facilities available, the adult can quickly assemble the potty from the blank as hereinbefore described to allow the child to sit on and use the potty. The blank is easily stored as it is flatpack, and as the inside of the potty is liquid-resistant, the potty once used does not leak. The handles can then be adhered to the top of the used potty to seal the potty shut and allow the potty to be carried and disposed of easily on arriving at the nearest facilities.

It will be appreciated by persons skilled in the art that the present invention may also include further additional modifications made to the device which does not affect the overall functioning of the device.

1. A potty characterized in that said potty is movable from a blank or flatpack condition to an erected condition for use.

2. A potty according to claim 1 characterised in that when erect the potty defines a cavity therein capable of containing liquid and/or other material.

3. A potty according to claim 2 characterised in that at least the base and walls which form the cavity are rendered liquid-resistant for a predetermined period of time.

4. A potty according to claim 1 characterised in that the blank includes one or more lines of weakening to allow erection thereof by folding.

5. A potty according to claim 1 characterised in that the blank includes at least two sections.

6. A potty according to claim 5 characterised in that engagement means are provided on the sections to allow retention of the sections in the erect form of the potty.

7. A potty according to claim 5 characterised in that a first section is folded inwardly to form a base and side walls of the potty, and a second section is folded inwardly to form the lid of the potty.

8. A potty according to claim 7 characterised in that the base is folded into the lid to form the erect potty.

9. A potty according to claim 5 characterised in that a first section is folded inwardly to form a base exterior of the erect potty, a second section is folded into the base exterior to form a base interior of the erect potty, and a third section is folded to form the lid of the erect potty.

10. A potty according to claim 5 characterised in that at least one section is folded inwardly at the corners to move the same into an erected condition, the outer positions of the section forming walls in the erected condition.

11. A potty according to claim 10 characterised in that the corners in the erected condition form points which extend along the outside and substantially in parallel with the walls.

12. A potty according to claim 10 characterised in that the corners in the erected condition form points which extend inwardly from the walls.

13. A potty according to claim 12 characterised in that the points are folded back on themselves to reduce the distance that the same extend from the walls.

14. A potty according to claim 1 characterised in that a lid is provided for the potty which includes one or more lines of weakening and/or frangible portions to allow an aperture to be defined therein for use of the potty.

15. A potty according to claim 1 characterised in that the potty includes one or more handles.

16. A potty according to claim 15 characterised in that the handles are provided with sealing means so as to act to seal the potty shut after use.

17. A potty according to claim 16 characterised in that the sealing means comprise any or any combination of adhesive, ties and or interlocking handles.

18. A blank of sheet material for use to form a potty, said blank includes at least two sections, said sections provided with one or more lines of weakening to allow erection of the blank by folding the same into a base, walls, and a lid, characterised in that at least one surface of the blank is liquid-resistant.

19. A blank of sheet material according to claim 18 wherein the blank includes three sections, said sections provided with one or more lines of weakening to allow erection of the blank by folding the same into a base exterior and exterior walls, a base interior and interior walls, and a lid.

20. A blank of sheet material according to claim 18 characterised in that both surfaces of the blank are liquid-resistant.

21. A blank of sheet material according to claim 18 characterised in that the blank is erected by hand to form a potty.

22. A disposable potty formed by folding a substantially flat blank into an erect condition, characterised in that at least one surface of the blank is liquid-resistant.

23. (canceled)
